(19) United States
(12) Patent Application Publication
(10) Pub. No.: US 2006/0158615 A1
(43) Pub. Date: Jul. 20, 2006

(54) Catadioptric 1x projection system and method

(76) Inventor: David M. Williamson, Tucson, AZ (US)

Correspondence Address: Lawrence R. Oremland, P.C., Suite C-214, 5055 E. Broadway Boulevard, Tucson, AZ, 85711, US

(21) Appl. No.: 11/037,534

(22) Filed: Jan. 18, 2005

(51) Int. Cl. G03B 21/26; G03B 21/28

(52) U.S. Cl. 353/37

(57) ABSTRACT

A new and useful method and projection system for projecting an image from an object plane to an image plane is provided. The method and system is designed to operate at a 1× magnification, a relatively high NA, with a relatively large instantaneous scanning field, and to achieve sub-micron resolution at high optical throughput. An object plane is scanned across an instantaneous rectangular field at least 40 mm in the direction of scan and at least 132 mm in a direction that is perpendicular to the scan, and the scanned image is projected onto the image plane through a catadioptric projection system configured for a 1× magnification and a numerical aperture of at least 0.23. The catadioptric projection system includes (i) a first field lens group configured to transmit an image ray bundle from the object plane, (ii) a first plane reflector configured to reflect and redirect the image ray bundle projected from the first field lens group, (iii) a second lens group in the optical path of the reflected, redirected image ray bundle, and a concave reflector following the second lens group, the concave reflector configured to reflect and return the reflected image ray bundle through the second lens group, (iv) a second plane reflector configured to reflect and redirect the returned image ray bundle, and (v) a third field lens group configured to receive and project the reflected, returned image ray bundle onto the image plane.

### BACKGROUND

The present invention relates to a catadioptric projection system and method for projecting an image from an object plane to an image plane.

A catadioptric projection system is a system that uses both refraction (e.g. one or more lens elements) and reflection (e.g. one or more mirrors) to project an image from an object plane to an image plane. Historically, catadioptric 1× projection lenses have been widely used in Microlithography. They generally operate close to a concentric condition (mirror and lens surface centers of curvatures coincident with object and image surfaces), by means of a concave mirror at 1× magnification, together with some aberration-correcting lens elements that also allow telecentric operation (entrance and exit pupils at infinity). Such designs offer significant advantages over equivalent 1× Dioptric projection lenses, including (a) considerably simpler in terms of number and size of lens elements, and (b) improved spectral bandwidth, resulting from low refracting power that allows less use of highly dispersive negative-powered lens elements to correct the chromatic aberrations of positively-powered lenses

However, in the applicant's experience, such prior systems have been limited to low numerical apertures (N.A.'s) or small field sizes. Moreover, they also suffer from relatively high residual aberrations, even at low NA's or field sizes, and tend to have severe obscuration problems as the NA or field sizes are increased. Thus, it is believed unlikely that they can be applied successfully to large-field, sub-micron resolution applications. Moreover, 1× systems have operated at higher NA's, but have generally operated only over significantly smaller field sizes for wafer stepper applications. More recently, derivatives of those systems have been proposed for large field scanning and stitching systems. However, such derivatives have had low NA's, which means that they cannot be used for large-field, sub-micron resolution, projection systems.

### SUMMARY OF THE INVENTION

An object of one aspect of the present invention is to provide a new and useful method and projection system configured to project an image from an object plane to an image plane in a manner that is designed to operate at a 1× magnification and a high NA.

A catadioptric projection system according to the present invention comprises:

a. a first lens group arranged in an optical path between the object plane and the image plane;

b. a first folding mirror arranged in an optical path between the first lens group and the image plane;

c. a concave reflector arranged in an optical path between the first folding mirror and the image plane;

d. a second folding mirror arranged in an optical path between the concave reflector and the image plane;

e. a second lens group arranged in an optical path between the first folding mirror and the concave reflector and between the concave reflector and the second folding mirror; and

f. a third lens group arranged in an optical path between the second folding mirror and the image plane.

Additional features of the present invention will become apparent from the following detailed description and the accompanying drawings and table.

### BRIEF DESCRIPTION OF THE DRAWINGS AND TABLE

FIG. 1 is a schematic illustration of a preferred embodiment of a catadioptric 1× projection system, according to the principles of the present invention;

FIG. 2 is a three dimensional illustration of components of the projection system of FIG. 1;

FIG. 3 is a side view, at a 100 mm scale, of the components shown in FIG. 2; and

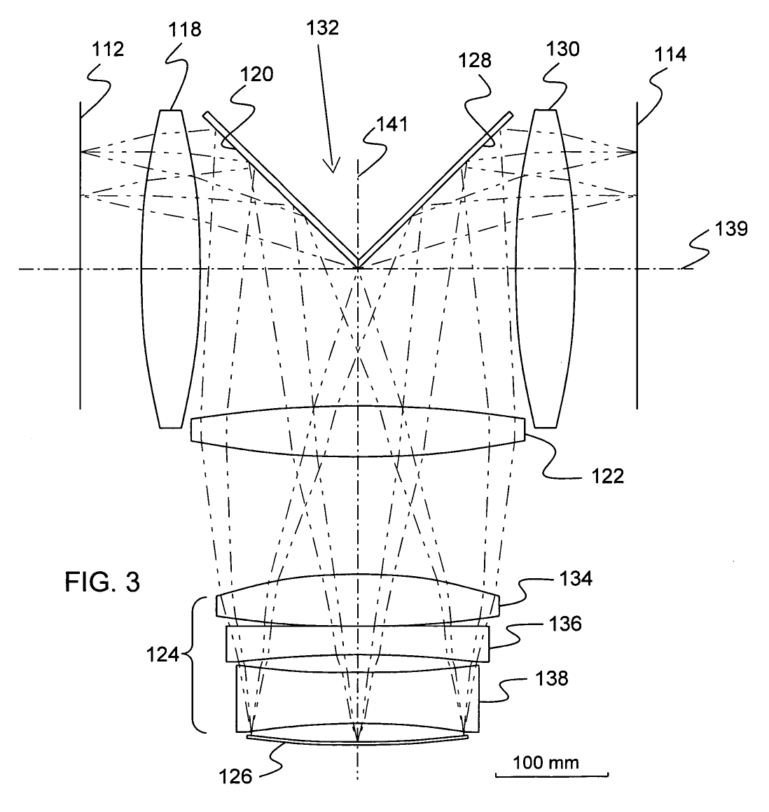

Table 1 is a prescription for the lens and mirror elements of the system of FIG. 3.

### DETAILED DESCRIPTION

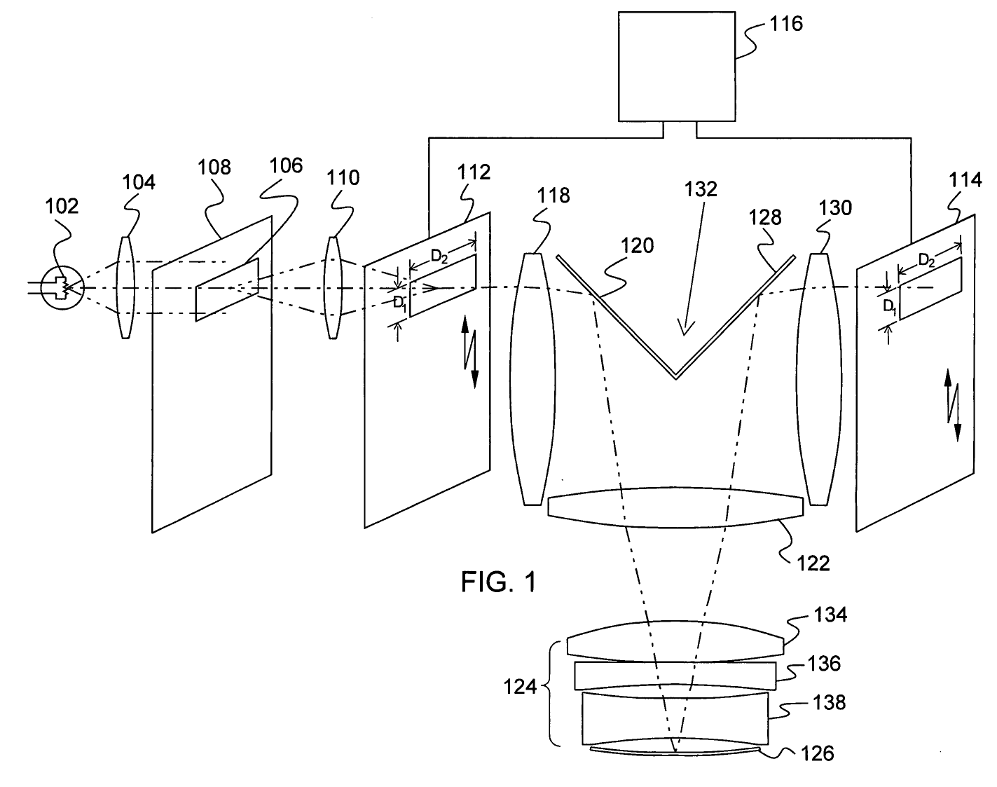

FIG. 1 illustrates one preferred embodiment of a catadioptric 1× projection system 100, according to the principles of the present invention. The system includes an illumination source 102, which according to the one embodiment emits light at the spectral bandwidth of the Mercury I line (365 nm). The light is collimated by a condenser lens 104, and directed through a rectangular aperture 106 in a diaphragm 108. A relay lens 110 projects an image of the rectangular diaphragm aperture 106 onto a mask 112, which forms an object plane of the system. The illumination optical system 104-110 may comprise an optical integrator for providing a uniform illumination distribution on the object plane and/or an image plane. The optical integrator can be a Fly's eye lenses and/or a Rod integrator. The rectangular diaphragm aperture of the diaphragm 108 can be modified to provide a trapezoidal diaphragm aperture, a hexagonal diaphragm aperture, or other polygonal diaphragm aperture. The projected diaphragm aperture image can be within a field of view of the catadiaptric projection system.

The rectangular image is projected from the object plane 112 to an image plane 114 by the catadioptric projection system of the present embodiment. The object plane 112 and the image plane 114 are supported for movement in synchronism with each other by support structure that is well known to those in the art. For example, see U.S. Pat. Nos. 5,640,227, 5,686,997, and 6,744,511, incorporated by reference herein. The object and image planes are preferably supported for movement parallel to each other either in the same directions or in opposite directions. A controller 116 is connected to the support structure, and is configured to move the object and image planes in synchronism with each other, again in a manner well known to those in the art.

As the object plane 112 moves relative to the diaphragm 108, a scanned rectangular image is produced at the object plane, and is projected to the image plane 114 by the refracting/reflecting components of the catadioptric projection system. Those refracting/reflecting components comprise (i) a first field lens group 118, (ii) a first plane mirror 120, (iii) a second lens group that includes a second field lens group 122 and a pupil lens group 124, (iv) a concave mirror 126, (v) a second plane mirror 128, and (vi) a third field lens group 130. The first and/or second plane mirrors 120, 128 may be modified to take the form of mirrors with slight curved reflection surface and/or mirrors with partially bent reflection surface.

For the one embodiment, as described further below, each of the first, second and third field lens groups comprises a single thin lens element. In this application, however, the term “field lens group” should not be limited to a single lens element. Rather, the term should be broadly construed to mean a single or a plurality of lens elements that are optically equivalent to a single lens element.

Moreover, as also discussed further below, the lens elements of the system 100, including the lens elements forming each of the first, second and third field lens groups (118, 122, 130) are preferably formed according to the lens prescription of Table 1. As can be seen from that table, the first and third field lens 118 and 130 have an identical optical prescription. Also, according to the one embodiment, the first and second plane mirrors 120, 128 are formed from a monolithic V fold mirror component 132. For example, see United States Published Patent Application No. US2003/0011755A, incorporated by reference herein. Still further, the pupil lens group 124 comprises lens elements 134, 136 and 138, each of which has a small diameter than the second field lens 122. The lens prescriptions for the pupil lens elements 134, 136, 138 are also shown in Table 1. This table 1 is CODE-V format.

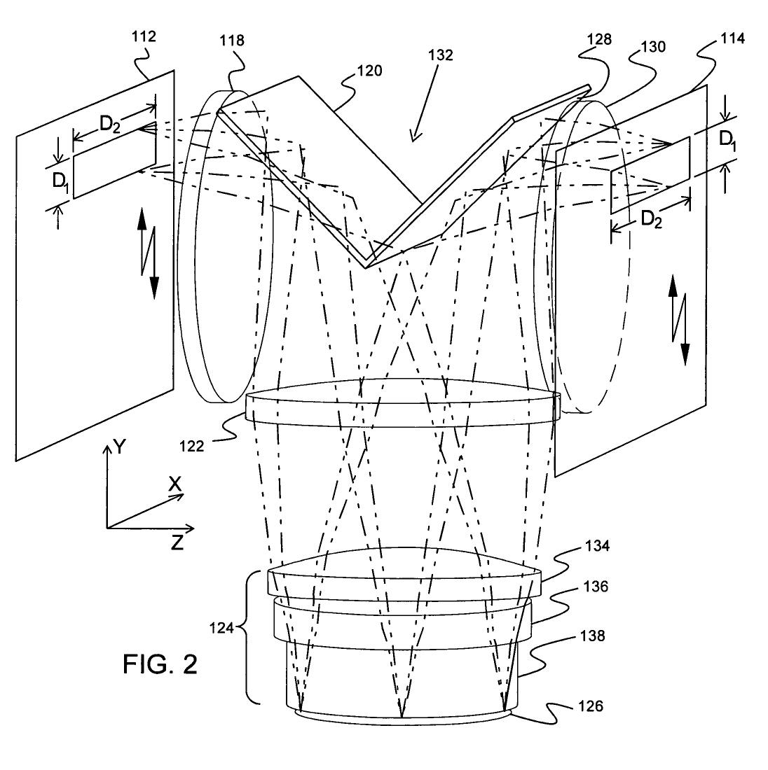

The first field lens group 118 is configured to transmit an image ray bundle from the instantaneous rectangular image at the object plane 112, as schematically illustrated in FIGS. 2 and 3. The first plane mirror 120 is configured to reflect and redirect the image ray bundle projected from the first field lens group 118. The second lens group 122, 124 is in the optical path of the reflected, redirected image ray bundle, and the concave mirror 126 follows the second lens group. The pupil lens group 124 transmits the image ray bundle to and from the concave reflector 126. The concave reflector 126 forms a pupil, and is configured to reflect and return the reflected image ray bundle through the pupil lens group 124 and the second field lens group 122. The second plane mirror 128 is configured to reflect and redirect the returned image ray bundle, and the third field lens group 130 is configured to receive and project the reflected, returned image ray bundle onto the image plane 114.

The projection 100 of the embodiment can be configured for a 1× magnification. Moreover, the projection 100 is configured for projecting a rectangular instantaneous scanned field with a numerical aperture of at least 0.23. In addition, the projection 100 can be further configured for projecting a rectangular scanned field that can be at least 40 mm in the direction of scan and 132 mm in a direction that is perpendicular to the scan. In FIGS. 1 and 2, the 40 mm dimension is shown at D1 and the 132 mm dimension is shown at D2. In FIG. 3, the 40 mm dimension is in the plane of the figure, and the 132 mm dimension is perpendicular to the plane of the figure.

According to the one embodiment, at least one of the field lens groups (118, 122, 130) has a lens with an aspheric surface configured to correct for aberrations. More preferably, each of the first, second and third field lens groups 118, 122, and 130 has a lens with an aspheric surface configured to correct for aberrations. Table 1 shows the aspheric lens surfaces, according to the preferred lens prescription.

Also, according to the one embodiment, the spatial relationships between the first field lens group 118 and the object plane 112, and between the third field lens group 130 and the image plane 114, are selectively and independently adjustable. In general, the field lens groups 118, 130 would be adjustable in X, Y or Z directions (see FIG. 2) relative to the object and/or image planes 112, 114 (as the case may be) in order to adjust that spatial relationship. Additionally, the spacing between the first field lens group 118 and the object plane 112 is configured to enable non-optical mechanical structure of a projection system to be disposed therein without interfering with the projection of the image ray bundle from the object plane to the image plane. The field lens groups 118, 130 can be tiltable about X, Y, and/or Z directions relative to the object and/or image planes 112, 114.

The system can be preferably configured for telecentric operation, and can be configured to correct for telecentricity errors, as described further below. Telecentric operation is useful because it is desirable that the size of the projected rectangular image does not change with changes in position of the object plane or the focus of the system.

Still further, the lens of each of the field lens groups is preferably formed of fused silica, which enhances the ability of the system to transmit the image ray bundle at shorter wavelength, preferably bellow 400 nm (e.g. at the spectral bandwidth of the Mercury I line (365 nm)). The lens elements (134, 136, 138) forming the pupil lens group 124 are each formed of material (e.g. optical glass) other than fused silica and have a smaller diameter than lens elements of the second field lens group 122.

In projecting an image from the object plane 112 to the image plane 114, according to the method of the present embodiment, the object plane 112 can be scanned across an instantaneous rectangular field at least 40 mm in the direction of scan and 132 mm in a direction that is perpendicular to the scan (i.e. the instantaneous field defined by the rectangle with dimensions D1 and D2 in FIGS. 1, 2), and the scanned image can be projected onto the image plane 114 by the catadioptric projection system, which is configured for a 1× magnification and a numerical aperture of at least 0.23. The step of projecting the scanned image includes the steps of (a) transmitting an image ray bundle from the object plane 112 through the first field lens group 118 and along a first optical axis (in FIG. 3, the first optical axis for the image ray bundle transmitted from the object plane through the first field lens group 118 is shown at 139), (b) redirecting the image ray bundle through the second field lens group 122 in a direction perpendicular to the first optical axis (in FIG. 3, the optical axis for the redirected image ray bundle is shown at 141), and (c) projecting the image ray bundle onto the image plane 114 through the third field lens group 130 that has an identical optical prescription to the first field lens group 118.

As described above, the 40 mm dimension of the object and image fields (i.e. dimension D1) are in the plane of FIG. 3, while the 132 mm dimension (i.e. D2) is perpendicular to it. Synchronous scanning of the object and image planes past the projection optics takes place in the direction of the 40 mm field dimension, i.e. in the plane of FIG. 3. The width of the scanned field is therefore 132 mm, and the length of the scanned field is limited only by practical sizes of the scanning mechanism and reticle (i.e. the diaphragm aperture 106).

Further, as also described above, the plane mirrors 120, 128 are preferably manufactured as a monolithic V-shaped mirror that covers only the used apertures of the light beams. An intersection line of an extension plane of the reflecting surface of the first plane mirror 120 and an extension plane of the reflecting surface of the second plane mirror 128 can be set up so that the optical axis of the first and/or third field lens group 118, 130 and the optical axis of the concave mirror 126, the pupil lens group, and/or the second field lens group intersect at one point. The catadioptric system of the present embodiment can be a coaxial optical system. It is preferable that the optical axis of the first and/or third field lens group 118, 130 and the optical axis of the concave mirror 126, the pupil lens group, and/or the second field lens group is perpendicular each other. Similarly, field lens elements 118 and 130 would not be manufactured as complete circular lens elements, but truncated as necessary to avoid mechanical interferences and obscuration of the light beams. Since, as indicated by the light rays bundles illustrated in FIGS. 2 and 3, less that one half of the full circular of field lens elements 118 and 130 is illuminated, and they have identical optical prescriptions, it would be possible, in principle, to manufacture only one element and cut it in half to make field lens elements 118 and 130.

The preferred method and device of the present embodiment provide a specific 1× catadioptric optical design at NA 0.23, which covers a relatively large field size of at least 132 mm by at least 40 mm at this relatively high NA, while at the same time achieving small residual aberrations over the entire spectral bandwidth of the Mercury I-line, and satisfying practical constraints for physical clearances, lens element materials and sizes. This allows sub-micron imaging resolution over an unusually large field, with a high optical throughput, and a relatively compact overall package.

Moreover, the preferred device of the present embodiment abandons the concentricity often found in catadioptric systems, but there are several unexpected advantages in doing this, when both a high NA and large field size are desired, at the same time as smaller system size and residual aberrations. Specifically, the two thin field lenses 118, 130 may be positioned on respective sides of the plane fold mirrors 120, 128, to make the object and image planes 112, 114 accessible and parallel for scanning or stepping. This has the advantage of avoiding what would be relatively large lenses and prisms used in some concentric catadioptric systems. It also improves the restricted clearance between these field lens elements, plane mirrors, and object and image planes, which allows increase in both the NA and field size at the same time, while maintaining lens diameters within practical limits.

The use of aspheric surfaces on at least one, and preferably all three, of the field lens elements 118, 122 and 130 allows good correction of telecentricity errors, which has been stated to be the cause of residual higher order astigmatism and oblique spherical aberration in some prior-Wynne-Dyson designs. This feature enables the preferred method and device of the invention to achieve a combination of high NA, large instantaneous field size and small residual aberrations.

Also, as described herein, thin field lens elements 118, 122 and 130 can all be made of fused silica, which has excellent transmission at the spectral bandwidth of the Mercury I-line, and is commercially available with high homogeneity at diameters of 300 mm. The correction of chromatic variation of focus is achieved, by the three relatively small and thin pupil lens elements, 134, 136 and 138 (whose prescriptions are provided in Table 1). These pupil lens elements have diameters less than 250 mm, which is within available sizes for the high quality I-line optical glasses used in these elements, as described in Table 1.

Additionally, field lens elements 118 and 130 have identical optical prescriptions, but are physically separate, in contrast with prior Wynne-Dyson designs where all elements operate in double-pass mode (the light passes in both directions through them, once from the object and once towards the image). This allows additional degrees of freedom, in terms of independent adjustments of elements 118 and 130 along and perpendicular to the optical axis, which may be used to control small isotropic magnification variations (of the order of 30 ppm) away from the exact 1× design, as well as isotropic and anisotropic distortion adjustments.

Still further, with the present embodiment there is a relatively long physical clearance between the object plane 112 and field lens element 118, and between field lens element 130 and the image plane 114. In a preferred system, with the lens prescription of Table 1, that clearance is 55 mm. In addition, the pupil lens group 124 elements (i.e. lens elements 134, 136 and 138), and concave mirror 126, are all relatively small in diameter. These features facilitate mechanical packaging of the lens element mountings and scanning stages, and result in an unusually compact system.

In addition, the field of the system of the present embodiment has a relatively large rectangular instantaneous field shape. The area of the instantaneous field determines how much light can pass through the optical system, which affects the scanning speed. A longer dimension in the scan direction allows a longer exposure time at a given scan speed, or the same exposure time at a faster scan. Longer field dimension perpendicular to the scan means that fewer scans are required to cover a given area flat panel display. Faster and fewer scans means higher throughput of flat panels through the system, therefore lower production cost for products such as flat panel displays that may, e.g. be hung on a wall.

Also, the first and third field lens elements 118 and 130 allow smaller residual aberrations over a larger instantaneous field size, especially when the lens elements make use of aspheric surfaces. They allow, at the same time, a higher NA (numerical aperture), which in turn allows the resolution of smaller feature sizes on the flat panel, which is required for some electronic circuit elements in more recent and future flat panel displays. The NA of 0.23, operating at the spectral bandwidth of the Mercury I-line (365 nm), allows a resolution of approximately 0.5*wavelength/NA=800 nm (this formula in well-known to those skilled in the art of Microlithography).

An additional advantage of the first and third field lens elements 118 and 130 is that they can be independently adjustable in X, Y, Z directions relative to the object and image planes 112, 114 (see FIG. 2). Such adjustments can compensate for manufacturing-induced tolerance variations from the design prescription. For example, if manufacturing induced tolerance variations would change the designed 1× magnification, adjustment along the optical axis allows the system to be adjusted to maintain the 1× magnification. In the present embodiment, the first and third field lens elements 118 and 130 can be adjustable for compensating magnification. Aberrations of the catadioptric optical system can be adjustable with moving the first and third field lens elements 118 and 130 (e.g. X, Y shift of the field element, tilt about X, Y, Z direction of the field element, etc.).

In the present embodiment, the plane mirrors 120 and 128 may be adjustable in order to control an imaging characteristics of the catadioptric optical system. Also, at least one lens element of the pupil lens group, the second field lens, and/or the concave mirror may be adjustable in order to control an imaging characteristics of the catadioptric optical system.

The magnification of the catadioptric optical system of the present invention is not limited to the 1× (unit) magnification, it can also be reduction ratio or an enlargement ratio (magnification).

While in the above-described present embodiment achieves higher NA of 0.23 and broader field size of 40 mm*132 mm, the catadioptric optical system of the present invention is not limited to the above NA and field size. The catadioptric optical system of the present invention can have an NA over 0.23 and a broader field size of 40 mm*132 mm.

The catadioptric optical system of the present embodiment may have an aperture stop for control numerical aperture. The aperture stop may by arranged near the concave mirror.

The above-described present embodiment applies the scanning step mode of operation. The present invention is also applicable to a step-and-repeat mode reduction projection exposure apparatus in which mask patterns are transferred to a substrate in a static state of the mask and the substrate. The substrate is then moved in successive steps.

The above-described present embodiment applies the spectral bandwidth of the Mercury I-line (365 nm). The present invention is not limited to apply the spectral bandwidth of the Mercury I-line (365 nm), it can apply the spectral bandwidth of the Mercury G-line (426 nm) or H-line (405 nm), the spectral bandwidth of laser radiation (e.g. KrF excimer laser radiation with or without bandwidth narrowing, ArF excimer laser radiation with or without bandwidth narrowing, F₂ dimer laser radiation, etc.).

Accordingly, the foregoing description provides an optical system and method for projecting instantaneous scanned images from an object plane to an image plane in a manner that can operate at 1× magnification, high numerical aperture, large instantaneous field and high resolution. With the principles of the invention in mind, it is believed that various modifications and adaptations of the principles of the present invention will be apparent to those in the art.

TABLE 1

| ELEMENT | RADIUS OF | CURVATURE | | APERTURE | DIAMETER | |
|---|---|---|---|---|---|---|
| NUMBER | FRONT | BACK | THICKNESS | FRONT | BACK | GLASS |
| OBJECT | INF | | 54.9999 | | | |
| 118 | A(1) | −716.6338 CX | 51.5314 | 290.2883 | 293.2773 | Fused Silica |
| | | | 140.0000 | | | |
| | DECENTER(1) | | | | | |
| 120 | INF | | −124.7039 | 415.0312 | | REFL |
| 122 | A(2) | 708.8372 CX | −47.8997 | 300.0000 | 298.3131 | Fused Silica |
| | | −107.6450 | | | | |
| 134 | −418.9837 CX | 885.5359 CX | −47.3230 | 250.0000 | 241.0776 | Optical Glass 1 |
| | | | −1.0000 | | | |
| 136 | 8372.4039 CC | A(3) | −25.0000 | 232.6866 | 214.8621 | Optical Glass 2 |
| | | | −16.1742 | | | |
| 138 | 780.1790 CC | −577.8189 CC | −46.1828 | 212.5317 | 191.6633 | Optical Glass 1 |
| | | | −17.8918 | | | |
| | | | APERTURE STOP | 190.5642 | | |
| 126 | 664.1873 CC | | 17.8918 | 190.5642 | | REFL |
| 138 | −577.8189 CC | 780.1790 CC | 46.1828 | 191.6025 | 212.5316 | Optical Glass 1 |
| | | | 16.1742 | | | |
| 136 | A(4) | 8372.4039 CC | 25.0000 | 214.8621 | 232.6865 | Optical Glass 2 |
| | | | 1.0000 | | | |
| 134 | 885.5359 CX | −418.9837 CX | 47.3230 | 241.0775 | 249.9998 | Optical Glass 1 |
| | | | 107.6450 | | | |
| 122 | 708.8372 CX | A(5) | 47.8997 | 298.3127 | 299.9996 | Fused Silica |
| | | | 124.7039 | | | |
| | DECENTER(2) | | | | | |
| 128 | INF | | −140.0000 | 415.0302 | | REFL |
| 130 | −716.6338 CX | A(6) | −51.5314 | 293.2765 | 290.2875 | Fused Silica |

| | | | |
|---|---|---|---|
| | IMAGE DISTANCE = | −54.9999 | |
| IMAGE | INF | | 256.5607 |

NOTES
Positive radius indicates the center of curvature is to the right
Negative radius indicates the center of curvature is to the left
Dimensions are given in millimeters
Thickness is axial distance to next surface
Image diameter shown above is a paraxial value, it is not a ray traced value

ASPHERIC CONSTANTS
$Z = \frac{( CURV ) {Y}^{2}}{1 + {( 1 - ( 1 + K ) {( CURV ) }^{2} {Y}^{2} )}^{1 / 2}} \begin{matrix}+ ( A ) {Y}^{4} + ( B ) {Y}^{6} + ( C ) {Y}^{8} + ( D ) {Y}^{10} \\ + ( E ) {Y}^{12} + ( F ) {Y}^{14} + ( G ) {Y}^{16} + ( H ) {Y}^{18} + ( J ) {Y}^{20}\end{matrix}$

| | | K | A | B | C | D |
|---|---|---|---|---|---|---|
| ASPHERIC | CURV | E | F | G | H | J |
| A(1) | 0.00144697 | 0.000000 | 1.76566E−09 | 4.19369E−14 | −1.75617E−18 | 4.94784E−23 |
| | | −1.25993E−27 | 1.62550E−32 | 0.00000E+00 | 0.00000E+00 | 0.00000E+00 |
| A(2) | −0.00107500 | 0.000000 | −2.33396E−10 | 2.04453E−14 | 1.04688E−19 | 1.77726E−25 |
| | | 1.93646E−29 | −2.33893E−34 | 0.00000E+00 | 0.00000E+00 | 0.00000E+00 |
| A(3) | −0.00093358 | 0.000000 | −3.71354E−09 | −4.40095E−15 | −3.83163E−20 | −6.53758E−25 |
| | | 0.00000E+00 | 0.00000E+00 | 0.00000E+00 | 0.00000E+00 | 0.00000E+00 |
| A(4) | −0.00093358 | 0.000000 | −3.71354E−09 | −4.40095E−15 | −3.83163E−20 | −6.53758E−25 |
| | | 0.00000E+00 | 0.00000E+00 | 0.00000E+00 | 0.00000E+00 | 0.00000E+00 |
| A(5) | −0.00107500 | 0.000000 | −2.33396E−10 | 2.04453E−14 | 1.04688E−19 | 1.77726E−25 |
| | | 1.93646E−29 | −2.33893E−34 | 0.00000E+00 | 0.00000E+00 | 0.00000E+00 |
| A(6) | 0.00144697 | 0.000000 | 1.76566E−09 | 4.19369E−14 | −1.75617E−18 | 4.94784E−23 |
| | | −1.25993E−27 | 1.62550E−32 | 0.00000E+00 | 0.00000E+00 | 0.00000E+00 |

| | WAVELENGTHS (NM) | | | | |
|---|---|---|---|---|---|
| GLASS CODE | 368.01 | 366.51 | 365.01 | 363.51 | 362.01 |
| | REFRACTIVE INDICES | | | | |
| Fused Silica | 1.474155 | 1.474371 | 1.474589 | 1.474810 | 1.475035 |
| Optical Glass 1 | 1.615005 | 1.615334 | 1.615668 | 1.616007 | 1.616350 |
| Optical Glass 2 | 1.611371 | 1.611908 | 1.612455 | 1.613011 | 1.613576 |

DECENTERING CONSTANTS

| DECENTER | X | Y | Z | ALPHA | BETA | GAMMA |
|---|---|---|---|---|---|---|
| D(1) | 0.0000 | 0.0000 | 0.0000 | 45.0000 | 0.0000 | 0.0000 (BEND) |
| D(2) | 0.0000 | 0.0000 | 0.0000 | 45.0000 | 0.0000 | 0.0000 (BEND) |

A decenter defines a new coordinate system (displaced and/or rotated) in which subsequent surfaces are defined.
Surfaces following a decenter are aligned on the local mechanical axis (z-axis) of the new coordinate system. The
new mechanical axis remains in use until changed by another decenter. The order in which displacements and
tilts are applied on a given surface is specified using different decenter types and these generate different new
coordinate systems; those used here are explained below. Alpha, beta, and gamma are in degrees.
DECENTERING CONSTANT KEY:

| TYPE | TRAILING CODE | ORDER OF APPLICATION |
|---|---|---|
| DECENTER | | DISPLACE (X,Y,Z) |
| | | TILT (ALPHA,BETA,GAMMA) |
| | | REFRACT AT SURFACE THICKNESS TO NEXT SURFACE |
| DECENTER & BEND | BEND | DECENTER (X,Y,Z,ALPRA,BETA,GAMMA) |
| | | REFLECT AT SURFACE BEND (ALPHA,BETA,GAMMA) |
| | | THICKNESS TO NEXT SURFACE |

| | |
|---|---|
| REFERENCE WAVELENGTH = | 365.0 NM |
| SPECTRAL REGION = | 362.0 − 368.0 NM |

This is a decentered system. If elements with power are decentered or tilted, the first order properties are probably
inadequate in describing the system characteristics.
INFINITE CONJUGATES

| | | |
|---|---|---|
| EFL | = | −2628.3988 |
| BFL | = | 2573.3971 |
| FFL | = | 2573.3971 |
| F/NO | = | 1.0578 |

AT USED CONJUGATES

| | | |
|---|---|---|
| REDUCTION | = | 1.0000 |
| FINITE F/NO | = | 2.1739 |
| OBJECT DIST | = | 54.9999 |
| TOTAL TRACK | = | 0.0000 |
| IMAGE DIST | = | −54.9999 |
| OAL | = | 0.0000 |
| PARAXIAL | | |
| IMAGE HT | = | 128.2801 |
| IMAGE DIST | = | −55.0035 |
| SEMI-FIELD | | |
| ANGLE | = | 1.3979 |
| ENTR PUPIL | | |
| DIAMETER | = | 2484.7404 |
| DISTANCE | = | 5201.7960 |
| EXIT PUPIL | | |
| DIAMETER | = | 2484.7404 |
| DISTANCE | = | 5201.7960 |

NOTES
FFL is measured from the first surface
BFL is measured from the last surface

1. A catadioptric projection system for projecting an image from an object plane to an image plane, comprising:
a. a first lens group arranged in an optical path between the object plane and the image plane;
b. a first folding mirror arranged in an optical path between the first lens group and the image plane;
c. a concave reflector arranged in an optical path between the first folding mirror and the image plane;
d. a second folding mirror arranged in an optical path between the concave reflector and the image plane;
e. a second lens group arranged in an optical path between the first folding mirror and the concave reflector and between the concave reflector and the second folding mirror; and
f. a third lens group arranged in an optical path between the second folding mirror and the image plane.

2. A catadioptric projection system as defined in claim 1, wherein the second lens group comprises a second field lens group and a pupil lens group between the second field lens group and the concave reflector.

3. A catadioptric projection system as defined in claim 2, wherein the projection system is configured for a 1× magnification.

4. A catadioptric projection system as defined in claim 3, wherein the projection system is further configured for projecting a rectangular instantaneous scanned field with a numerical aperture of at least 0.23.

5. A catadioptric projection system as defined in claim 4, wherein the projection system is further configured for projecting a rectangular scanned field that is at least 40 mm in the direction of scan and 132 mm in a direction that is perpendicular to the scan.

6. A catadioptric projection system as defined in claim 5, wherein at least one of the field lens groups has a lens with an aspheric surface configured to correct for aberrations.

7. A catadioptric projection system as defined in claim 6, wherein each of the first and third field lens groups has a lens with an aspheric surface configured to correct for aberrations.

8. A catadioptric projection system as defined in claim 7, wherein the spatial relationship between the first field lens group and the object plane, and the third lens group and image plane, are selectively adjustable.

9. A catadioptric projection system as defined in claim 8, wherein the lens of each of the field lens groups is formed of fused silica.

10. A catadioptric projection system as defined in claim 9, wherein the first and third field lens groups have identical prescriptions.

11. A catadioptric projection system as defined in claim 10, wherein the image ray bundle is transmitted over the spectral bandwidth of the Mercury I line.

12. A catadioptric projection system as defined in claim 10, wherein lens elements of the pupil lens group are formed of lens material other than fused silica and have a smaller diameter than lens elements of the second field lens group.

13. A catadioptric projection system as defined in claim 10, wherein the first and second plane mirrors are configured as portions of a monolithic V-fold mirror.

14. A catadioptric projection system as defined in claim 10, wherein the spacing between the first field lens group and the object plane is configured to enable non optical mechanical structure of a projection system to be disposed therein without interfering with the projection of the image ray bundle from the object plane to the image plane.

15. A catadioptric projection system as defined in claim 10, wherein at least one of the first and third field lens groups is configured for telecentric operation.

16. A catadioptric projection system as defined in claim 15, wherein the first field lens group is configured for telecentric operation.

17. A catadioptric projection system as defined in claim 4, wherein the lens of each of the field lens groups is formed of fused silica.

18. A catadioptric projection system as defined in claim 17, wherein the projection system is further configured for projecting a rectangular scanned field that is at least 40 mm in the direction of scan and 132 mm in a direction that is perpendicular to the scan.

19. A catadioptric projection system as defined in claim 18, wherein at least one of the field lens groups has a lens with an aspheric surface configured to correct for aberrations.

20. A catadioptric projection system as defined in claim 19, wherein the first and third field lens groups have identical optical prescriptions.

21. A catadioptric projection system as defined in claim 5, wherein the spatial relationship between the first field lens group and the object plane, and the third lens group and the image plane, are independently adjustable.

22. A catadioptric projection system as defined in claim 4, wherein the spatial relationship between the first field lens group and the object plane, and between the third field lens group and the image plane, are independently adjustable.

23. A method of projecting an image from an object plane to an image plane, comprising the steps of
a. scanning the object plane across an instantaneous rectangular field at least 40 mm in the direction of scan and 132 mm in a direction that is perpendicular to the scan, and
b. projecting the scanned image onto the image plane through a catadioptric projection system configured for a 1× magnification and a numerical aperture of at least 0.23.

24. A method as defined in claim 23, further including the step of selectively adjusting the spatial relationship of the object plane relative to selected portions of the catadioptric projection system to provide optical adjustment of the projected image.

25. A method as defined in claim 24, wherein the step of projecting the scanned image includes the steps of (a) transmitting an image ray bundle from the object plane through a first field lens group and along a first optical axis, (b) redirecting the image ray bundle through a second field lens group in a direction transverse to the first optical axis, and (c) projecting the image ray bundle onto the image plane through a third lens group that has an identical optical prescription to the first field lens group.

26. A method as defined in claim 23, wherein the step of projecting the scanned image includes the steps of (a) transmitting an image ray bundle from the object plane through a first field lens group and along a first optical axis, (b) redirecting the image ray bundle through a second field lens group in a direction transverse to the first optical axis, and (c) projecting the image ray bundle onto the image plane through a third lens group that has an identical optical prescription to the first field lens group.

27. An apparatus, comprising:
an image plane;
an object plane defining an image to be projected onto the image plane; and
a 1× Catadiaptric imaging system, optically positioned between the object plane and the image plane, and configured to project the image defined by the object plane onto the image plane, the 1× Catadioptric imaging system comprising:
a pair of folded mirrors; and
a first aspheric element optically positioned between the object plane and the pair of folded mirrors.

28. The apparatus of claim 27, further comprising a second aspheric element optically positioned between the pair of folded mirrors and the image plane.

29. The apparatus of claim 28, wherein the first aspheric element and the second aspheric element have the same optical prescription.

30. The apparatus of claim 27, wherein the first aspherica element is provided in a first lens group configured to transmit an image ray bundle from the object plane to the pair of folded mirrors.

31. The apparatus of claim 30, further comprising a second lens group configured to receive the image ray bundle from one of the pair of folded mirrors and to reflect the image ray bundle to a second of the pair of folded mirrors.

32. The apparatus of claim 28, wherein the second aspheric element is provided in a third lens group configured to transmit an image ray bundle from the pair of folded mirrors to the image plane.

33. The apparatus of claim 32, wherein the 1× Catadioptric imaging system is further configured for projecting a rectangular instantaneous scanned field with a numerical aperture of at least 0.23.

34. The apparatus of claim 33, wherein the 1× Catadioptric imaging system is further configured for projecting a rectangular scanned field that is at least 40 mm in the direction of scan and 132 mm in a direction that is perpendicular to the scan.

35. The apparatus of claim 34, wherein the spatial relationship between the first lens group and the object plane, and the third lens group and image plane, are selectively adjustable.

36. The apparatus of claim 35, wherein the image ray bundle is transmitted over the spectral bandwidth of the Mercury I line.

37. The apparatus of claim 36, wherein the pair of folded mirrors are configured as portions of a monolithic V-fold mirror.

38. The apparatus of claim 37, wherein the spacing between the first lens group and the object plane is configured to enable non optical mechanical structure of a projection system to be disposed therein without interfering with the projection of the image ray bundle from the object plane to the image plane.
